(19) United States
(12) Patent Application Publication
(10) Pub. No.: US 2026/0296064 A1
(43) Pub. Date: Oct. 1, 2026

(54) PRINTING SYSTEM AND PRINTING METHOD

(71) Applicant: SEIKO EPSON CORPORATION, Tokyo (JP)

(72) Inventor: Yuki MIYAMOTO, Matsumoto-shi (JP)

(21) Appl. No.: 19/630,588

(22) Filed: Mar. 27, 2026

(30) Foreign Application Priority Data
Mar. 28, 2025 (JP) 2025-055266

(51) Int. Cl. B41J 11/00; B41J 2/045; B41J 2/21; B41J 29/393

(52) U.S. Cl. CPC B41J 11/00212; B41J 2/04505; B41J 2/04558; B41J 2/2103; B41J 2/2117; B41J 11/00214; B41J 29/393; B41J 2/04586; B41J 2029/3935; B41J 2203/01

(57) ABSTRACT

A printing system according to an aspect of the present disclosure includes a print head configured to discharge a first ink and second ink to a medium, the first ink having a first color and being curable, and the second ink having a second color and being curable; a control unit configured to control discharge of the first ink and the second ink, a curer, and a sensor. The curer is configured to cure the first ink and the second ink discharged to the medium at different timings. The control unit is configured to control the print head to form a first pattern with the first ink. The control unit is configured to control the print head to discharge the second ink to the medium on which a product after the first ink of the first pattern is cured is formed in a way that the second ink is discharged to a second region containing a first region where the product is formed. The curer is configured to cure the second ink in the second region after a predetermined period elapses from the discharge of the second ink. The sensor is configured to sense a printed result using the first ink and the second ink after curing by the curer.

The present application is based on, and claims priority from JP Application Serial Number 2025-055266, filed Mar. 28, 2025, the disclosure of which is hereby incorporated by reference herein in its entirety.

### BACKGROUND

### 1. Technical Field

The present disclosure relates to a printing system and a printing method.

### 2. Related Art

JP-A-2017-124548 describes a technology for discharging transparent ink, curing the ink, and then discharging color ink to recessed portions of protruding and recessed portions formed by the transparent ink in order to improve graininess of a highlighted region at low cost without deterioration of image quality.

JP-A-2017-124548 is an example of the related art.

When a test pattern is printed by using the technology described in JP-A-2017-124548, however, various patterns are formed in the shape of the color ink in accordance with various phenomena occurring in the ink discharging operation, such as droplet flight deflection and the droplet discharge failure, so that it is difficult to determine the quality of the printed result and factors determining the printing quality. When the test pattern is an adjustment pattern used to adjust a landing position of color ink having poor visibility, the problem described above is more noticeable.

It is therefore desired to develop a technology that allows accurate sensing of an adjustment pattern used to adjust the landing position of ink on a medium even when the ink has a color difficult to visually recognize.

### SUMMARY

A printing system according to an aspect of the present disclosure includes: a print head configured to discharge first ink and second ink to a medium, the first ink being liquid having a first color and being curable, and the second ink being liquid having a second color and being curable; a control unit configured to control the print head to discharge the first ink and the second ink; a curer configured to cure the first ink and the second ink discharged to the medium at different timings; and a sensor configured to sense a printed result using the first ink and the second ink after curing by the curer, the control unit being configured to control the print head to form a first pattern with the first ink, and control the print head to discharge the second ink to the medium on which a first product is formed, the first product being a product after the first ink of the first pattern is cured, in a way that the second ink is discharged to a second region containing a first region where the first product is formed, and the curer being configured to cure the second ink in the second region after a predetermined period elapses from the discharge of the second ink.

A printing method according to an aspect of the present disclosure performed by a printing system includes a print head configured to discharge first ink and second ink to a medium to print a first pattern, the first ink being liquid having a first color and being curable, and the second ink being liquid having a second color and being curable, the printing method including: controlling the print head to form the first pattern with the first ink; curing the first of ink the formed first pattern; controlling the print head to discharge the second ink to the medium at which a first product is formed, the first product being a product after the first ink of the first pattern is cured, in a way that the second ink is discharged to a second region containing a first region where the first product is formed; curing the second ink in the second region after a predetermined period elapses from the discharge of the second ink; and sensing a printed result using the first ink and second ink after curing┘.

### BRIEF DESCRIPTION OF THE DRAWINGS

FIG. 1 is a diagrammatic view showing an example of the configuration of a printing system according to an embodiment.

FIG. 2 is a diagrammatic view in which an example of recording heads in the printing system in FIG. 1 is drawn in the form of a planar development.

FIG. 3 is a diagrammatic view showing an example of an adjustment pattern printed in the printing system in FIG. 1.

FIG. 4 is a diagrammatic view showing an X-direction cross section of the adjustment pattern shown in FIG. 3 taken along the one-dot chain line in a Y-direction pattern.

FIG. 5 is a diagrammatic view showing the process of forming the adjustment pattern shown in FIG. 3.

FIG. 6 is a diagrammatic view showing how the Y-direction pattern shown in FIGS. 3 and 4 is sensed by a sensor of the printing system.

FIG. 7 is a flowchart showing an example of a landing position adjustment method including a printing method used with the printing system shown in FIG. 1.

### DESCRIPTION OF EMBODIMENTS

An embodiment of the present disclosure will be described below with reference to the drawings. Note that the drawings are merely examples for illustrating the embodiment of the present disclosure. Furthermore, all the elements described in the embodiment of the present disclosure are not essential configuration requirements of the present disclosure.

### EMBODIMENT

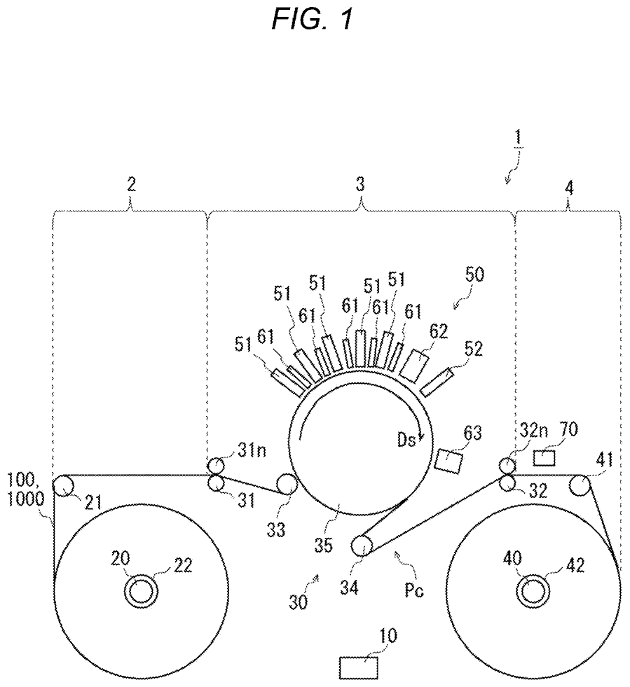

An example of the configuration of a printing system according to the embodiment of the present disclosure will be described with reference to FIG. 1. FIG. 1 is a diagrammatic view showing an example of the configuration of the printing system.

A printing system 1 shown in FIG. 1 includes a control unit 10, a feeding shaft 20, a conveyor 30, a winding shaft 40, a printing unit 50, and a sensor 70. It can be 1 includes a printing said that the printing system apparatus primarily configured with the feeding shaft 20, the conveyor 30, the winding shaft 40, the printing unit 50, and the control unit 10, which controls the elements described above.

The control unit 10 controls the operation of each of the elements of the printing system 1. The control unit 10 controls the printing system 1, and may therefore be referred to as a controller. The control unit 10 may control at least discharge of ink via a print head and curing of the discharged ink, and may further control other portions such as control of the sensor 70.

The control unit 10 may include an arithmetic processing device such as a CPU or a GPU, a working memory, and a storage device that stores a control program, parameters, and other pieces of information. CPU is an abbreviation for a central processing unit. GPU is an abbreviation for a graphics processing unit. The control unit 10 may instead be configured with a system on a chip (SoC). As can be seen from the examples described above, the control unit 10 can be configured to store the control program in an executable manner. Note, however, that the control unit 10 can instead be configured to store the control program as a circuit element such as a field-programmable gate array (FPGA), or can instead be configured with a dedicated circuit. The program described above can include a program that performs control related to ink discharge and irradiation for ink curing, and sensing of an adjustment pattern or sensing thereof and adjustment of a landing position, as will be described below.

Note that the printing system 1 can include a group of detectors none of which is shown in addition to the sensor 70, that the group of detectors can monitor the situation in the printing system 1, and that the control unit 10 can control the elements of the printing system 1 based on the results of detection performed by the group of detectors.

The feeding shaft 20 feeds a base material 100, which is a medium on which printing is performed. The conveyor 30 conveys the fed base material 100. The printing unit 50 performs printing on the base material 100 conveyed by the conveyor 30. The winding shaft 40 winds printed matter 1000, which is the base material 100 on which printing has been performed. At the time of printing the adjustment pattern, the sensor 70 optically reads the printed matter 1000 before being wound around the winding shaft 40, and senses the adjustment pattern formed on the printed matter 1000.

In the printing system 1, the elongated base material 100 wound in the shape of a roll around the feeding shaft 20 and the winding shaft 40 is stretched along a conveyance path Pc. The base material 100 receives image printing while being conveyed in a conveyance direction Ds at a rotary drum 35 provided between the feeding shaft 20 and the winding shaft 40.

The base material 100 is broadly classified into a paper-based material and a film-based material. Specific examples of the paper-based material include high-quality paper, cast paper, art paper, and coated paper, and examples of the film-based material include synthetic paper, polyethylene terephthalate (PET), and polypropylene (PP). The base material 100 may have any color.

The printing system 1 is divided into three functional regions: a feeding region 2; a processing region 3; and a winding region 4. The feeding region 2 is a region where the base material 100 is fed from the feeding shaft 20. The processing region 3 is a region where liquid is discharged to the base material 100 fed from the feeding region 2. A product formed by the liquid discharged in the processing region 3 may be called an image layer. The winding region 4 is a region where the printed matter 1000, on which the image layer has been formed in the processing region 3, is wound around the winding shaft 40. Note in the following description that out of opposite surfaces of the base material 100, a surface on which the image layer is formed is referred to as a front surface, and the surface opposite the surface on which the image layer is formed is referred to as a rear surface.

The feeding region 2 includes the feeding shaft 20, around which one end portion of the base material 100 is wound, and a driven roller 21, with which the base material 100 drawn from the feeding shaft 20 engages. The feeding shaft 20 supports the base material 100 with one end portion thereof wound around the feeding shaft 20, and the front surface of the base material 100 faces outward. When the feeding shaft 20 rotates clockwise in FIG. 1, the base material 100 wound around the feeding shaft 20 is fed to the processing region 3 via the driven roller 21.

The driven roller 21 is in contact with the base material 100 and is driven to rotate in the conveyance direction Ds of the base material 100 with the aid of a frictional force between the driven roller 21 and the conveyed base material 100. The base material 100 is wound around the feeding shaft 20 via a core tube 22, which is attachable to and detachable from the feeding shaft 20. When the base material 100 around the feeding shaft 20 is used up, a new core tube 22 around which the base material 100 is wound in the form of a roll is attached to the feeding shaft 20.

The processing region 3 includes the conveyor 30 and the printing unit 50, which performs printing on the base material 100 conveyed by the conveyor 30. The conveyor 30 is provided with a front driving roller 31, the rotary drum 35, which supports the base material 100 in a cylindrical shape, and a rear driving roller 32. The printing unit 50 is provided with recording heads 51 and 52 and UV irradiators 61, 62, and 63 as the print head.

In the processing region 3, the base material 100 fed from the feeding region 2 is supported by the rotary drum 35, and the recording heads 51 and 52 and the UV irradiators 61, 62, and 63 disposed along the outer circumferential surface of the rotary drum 35 appropriately perform processing on the base material 100. The processing forms the image layer at the base material 100 in the processing region 3.

The front driving roller 31, which conveys the base material 100 toward the rotary drum 35, is disposed at an upstream position in the processing region 3. The rear driving roller 32, which conveys the base material 100 toward the winding shaft 40, is disposed at a downstream position in the processing region 3. The rotary drum 35 supports the base material 100 conveyed from the front driving roller 31 to the rear driving roller 32.

The front driving roller 31 has a cylindrical or columnar shape having an outer circumferential surface with multiple minute protrusions formed by thermal spraying, and the base material 100 fed from the feeding region 2 engages with the front driving roller 31 with the rear surface of the base material 100 facing the outer circumferential surface of the front driving roller 31. The front driving roller 31 then rotates clockwise in FIG. 1 to cause the base material 100 fed from the feeding region 2 to be conveyed downstream along the conveyance path Pc.

A nip roller 31n is disposed so as to face the front driving roller 31. The nip roller 31n is in contact with the front surface of the base material 100 while being urged toward the front driving roller 31, and the base material 100 is sandwiched between the nip roller 31n and the front driving roller 31. A frictional force between the front driving roller 31 and the base material 100 is thus secured, so that the base material 100 can be reliably conveyed by the front driving roller 31.

The rotary drum 35 is a cylindrical drum supported in a rotatable manner, and the base material 100 conveyed from the front driving roller 31 to the rear driving roller 32 engages with the rotary drum 35 with the rear surface of the base material 100 facing the outer circumferential surface of the rotary drum 35. The rotary drum 35 receives a frictional force between the rotary drum 35 and the conveyed base material 100 while supporting the base material 100 via the rear surface thereof, and is driven to rotate in the conveyance direction Ds of the base material 100.

The processing region 3 is provided with driven rollers 33 and 34, which are disposed on opposite sides, in the conveyance direction Ds, of the region where the base material 100 engages with the rotary drum 35 and change the traveling direction of the base material 100.

The driven roller 33, which is disposed between the front driving roller 31 and the rotary drum 35 in the conveyance direction Ds and with which the front surface of the base material 100 engages, reverses the traveling direction of the base material 100 toward the rotary drum 35.

The driven roller 34, which is disposed between the rotary drum 35 and the rear driving roller 32 in the conveyance direction Ds and with which the front surface of the base material 100 engages, reverses the traveling direction of the base material 100. Reversing the base material 100 at positions upstream and the downstream of the rotary drum 35 in the conveyance direction Ds allows the base material 100 to securely engage with the rotary drum 35 for a long distance.

The rear driving roller 32 has a cylindrical or columnar shape having an outer circumferential surface with multiple minute protrusions formed by thermal spraying, and the base material 100 conveyed from the rotary drum 35 via the driven roller 34 engages with the rear driving roller 32 with the rear surface of the base material 100 facing the outer circumferential surface of the rear driving roller 32. The rear driving roller 32 rotates clockwise in FIG. 1 to convey the base material 100 to the winding region 4. A nip roller 32n is disposed so as to face the rear driving roller 32.

The nip roller 32n is in contact with the front surface of the base material 100 while being urged toward the rear driving roller 32, and the base material 100 is sandwiched between the nip roller 32n and the rear driving roller 32. A frictional force between the rear driving roller 32 and the base material 100 is thus secured, so that the base material 100 can be reliably conveyed by the rear driving roller 32.

The base material 100 conveyed from the front driving roller 31 to the rear driving roller 32 is thus supported by the outer circumferential surface of the rotary drum 35. Thereafter, in the processing region 3, multiple recording heads 51 corresponding to different colors are provided to print a color image at the front surface of the base material 100 supported by the rotary drum 35. FIG. 1 shows a case where five recording heads 51 are arranged in the conveyance direction Ds, but the number of the recording heads 51 is not limited to five, and two or more recording heads 51 for any color such as black may be provided.

The recording heads 51 each face the front surface of the base material 100 having engaged with the rotary drum 35 with slight clearance between the recording head 51 and the front surface of the base material 100, and discharge corresponding color ink in accordance with an inkjet method onto the base material 100 via a nozzle provided at the recording head 51. The printing system 1 uses, as the ink, ultraviolet curable ink that cures when irradiated with ultraviolet light, and forms the image layer on the base material 100. The ultraviolet curable ink is hereinafter also referred to as UV ink.

Note that the UV ink is a type of photocurable ink, contains an ultraviolet curable resin, and cures when a photopolymerization reaction occurs in the ultraviolet curable resin irradiated with ultraviolet light. The ink used in the printing system 1 is, however, not limited to UV ink, and may be liquid that changes in response to active energy irradiation other than ultraviolet light, such as light having another wavelength band or an electron beam. That is, the printing system 1 can also be configured as a printing system of another type that discharges such liquid onto a medium, cures the liquid with the aid of active energy irradiation, and fixes the liquid to the medium.

The processing region 3 is provided with the UV irradiators 61 and 62 to cure the ink and fix the cured ink to the base material 100. The ink is cured in separate two stages, temporary curing and final curing. The UV irradiators 61 for temporary curing are disposed between the multiple recording heads 51. The UV irradiators 61 irradiate ultraviolet light having a weak irradiation intensity to temporarily cure the ink in a way that the speed at which the ink spreads over and wets the base material 100 is sufficiently slow as compared with the speed in a case where no ultraviolet light is irradiated. Occurrence of color mixture, for example, a situation in which multiple types of color ink having different colors mix with each other, is thus suppressed. The ink may, however, be cured in separate three or more stages, or at once except when the adjustment pattern, which will be described later, is printed. In addition, for example, a downstream one of the UV radiators 61, which cures white ink that is discharged by a large amount as an undercoat, may be used to perform the final curing.

The UV irradiator 62 for the final curing is provided downstream of the multiple recording heads 51 in the conveyance direction Ds. The UV irradiator 62 irradiates ultraviolet light more intensely than the ultraviolet light irradiated by the UV irradiators 61 to cure the ink to the extent that the ink stops spreading over and wetting the base material 100. A color image formed by the multiple recording heads 51 is cured by the UV irradiator 62 and fixed to the base material 100.

The recording head 52 is provided downstream of the UV irradiator 62 in the conveyance direction Ds. The recording head 52 faces the front surface of the base material 100 having engaged with the rotary drum 35 with slight clearance between the recording head 52 and the front surface of the base material 100, and discharges UV ink containing no coloring material in accordance with an inkjet method onto the base material 100 via a nozzle provided at the recording head 52. The UV ink containing no coloring material is also hereinafter referred to as transparent ink. That is, the transparent ink is further discharged to the image layer formed by the recording heads 51.

The UV irradiator 63 is provided downstream of the recording head 52 in the conveyance direction Ds. The UV irradiator 63 irradiates ultraviolet light more intensely than the ultraviolet light irradiated by the UV irradiators 61 to perform the final curing of the transparent ink discharged by the recording head 52. The transparent ink can thus be fixed to the front surface of the base material 100.

As described above, the printing system 1 includes a printing unit 50, the printing unit 50 including a print head that includes the recording heads 51 and 52 and the UV irradiators 61 to 63. The recording heads 51 are each an example of a recording head capable of discharging color ink, which is a colored and curable liquid, to the base material 100. The recording head 52 is an example of a recording head capable of discharging transparent ink, which is a colorless and curable liquid, to the base material 100. Note that the recording heads 51 and 52 themselves may each be referred to as a print head. As described above, the printing unit 50 in the present embodiment includes recording heads each capable of discharging curable ink to the base material 100 for each of multiple colors. That is, the printing unit 50 includes recording heads capable of discharging first ink that is curable liquid having a first color and second ink that is curable liquid having a second color to the base material 100.

The UV irradiators 61 to 63 are each an example of a curer that cures the ink discharged onto the base material 100. The curer is configured to cure the first ink and the second ink discharged to the base material 100 at different timings. The curer may be controlled by the control unit 10 when performing the curing operation, and that is the case in the description below.

As described above, in the processing region 3, the ink is appropriately discharged to and cured at the base material 100 that engages with the outer circumference of the rotary drum 35. The base material 100 with the cured ink, that is, the printed matter 1000 is conveyed to the winding region 4 by the rear driving roller 32.

In addition to the winding shaft 40, around which another end portion of the base material 100 has been wound, the winding region 4 includes a driven roller 41, which is disposed between the winding shaft 40 and the rear driving roller 32 and with which the base material 100 engages with the rear surface of the base material 100 facing the outer circumferential surface of the driven roller 41. The winding shaft 40 supports the base material 100 with the other end portion thereof wound around the winding shaft 40, and the front surface of the base material 100 faces outward.

That is, when the winding shaft 40 rotates clockwise in FIG. 1, the base material 100 conveyed from the rear driving roller 32 is wound around the winding shaft 40 via the driven roller 41. The base material 100 is wound around the winding shaft 40 via a core tube 42, which is attachable to and detachable from the winding shaft 40. Therefore, when the winding shaft 40 is full of the base material 100 wound therearound, the base material 100 can be detached along with the core tube 42.

The sensor 70 is provided in the winding region 4 so as to optically read and sense the printed result performed on the front surface of the printed matter 1000 before being wound around the winding shaft 40, as shown in FIG. 1. The printed result includes the printed result the adjustment pattern formed with the first ink and the second ink. The adjustment pattern in the description is a pattern used to adjust the landing position where the first ink, which is curable ink having the first color, is landed on the base material 100, and may be referred to as a test pattern for the first ink. That is, the sensor 70 senses the printed result of the adjustment pattern for the first ink printed with the first ink and the second ink having been cured by the curer. Note that the sensor 70 may be provided in the processing region 3 downstream of the UV irradiator 63.

The sensor 70 can, for example, be configured and arranged to optically read and sense at least the printed result on the medium while the medium is moved relative to the sensor along a reading direction. The landing position refers to an ink discharge position on the base material 100. When the printing system 1 includes the line-by-line printing unit 50 shown in FIG. 1 by way of example, the reading direction refers to a direction that coincides with the conveyance direction of the base material 100. Note that the conveyance direction of the base material 100, that is, the conveyance direction in which the base material is conveyed may be referred to as a base material conveyance direction.

Note that a computer that is not shown can be communicably connected to the printing system 1 in a wired or wireless manner, and that the computer outputs print data that causes the printing system 1 to print an image to the printing system 1. The printing system 1 having received the print data performs printing on the base material 100.

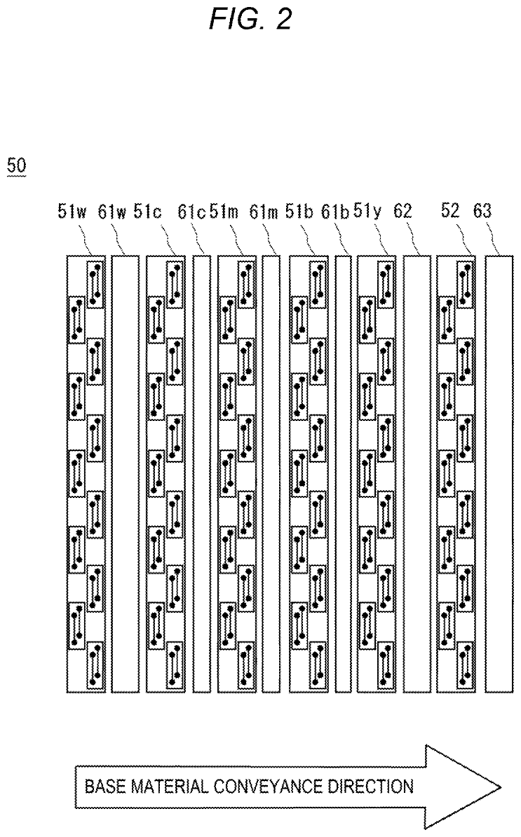

An example of the print head in the printing system 1 will next be described with reference to FIG. 2. FIG. 2 is a diagrammatic view in which an example of the print head, that is, an example of the printing unit 50 is drawn in the form of a planar development.

In the printing unit 50 shown in FIG. 2 by way of example, a white recording head 51w, a UV irradiator 61w for the final or temporary curing of white ink, a cyan recording head 51c, a UV irradiator 61c for the temporary curing, a magenta recording head 51m, a UV irradiator 61m for the temporary curing, a black recording head 51b, a UV irradiator 61b for the temporary curing, a yellow recording head 51y, the UV irradiator 62 for the final curing, the transparent ink recording head 52, and the UV irradiator 63 for the final curing of the transparent ink are disposed from the side upstream in the base material conveyance direction indicated by an arrow.

In each of the recording heads 51w, 51c, 51m, 51b, 51y, and 52, multiple nozzles that discharge ink having a corresponding color are arranged in a direction perpendicular to the base material conveyance direction, the nozzles arranged in the direction perpendicular to the base material conveyance direction form nozzle rows, and the nozzle rows form chip units. Note that FIG. 2 shows a case where the chip units each have two nozzle rows in each of the recording heads 51w, 51c, 51m, 51b, 51y, and 52, and the chip units are arranged in a staggered pattern. The example of the arrangement is, however, merely an arrangement for improving the discharge density, and both the nozzle rows and the chip units may be configured with one row or three or more rows. In addition, FIG. 2 shows a case where white ink, cyan ink, magenta ink, black ink, and yellow ink are used as the multiple types of color ink, and the colors to be employed and the number thereof are not limited thereto. The order of the colors in accordance with which the multiple types of color ink are arranged is not limited to the order shown in FIG. 2.

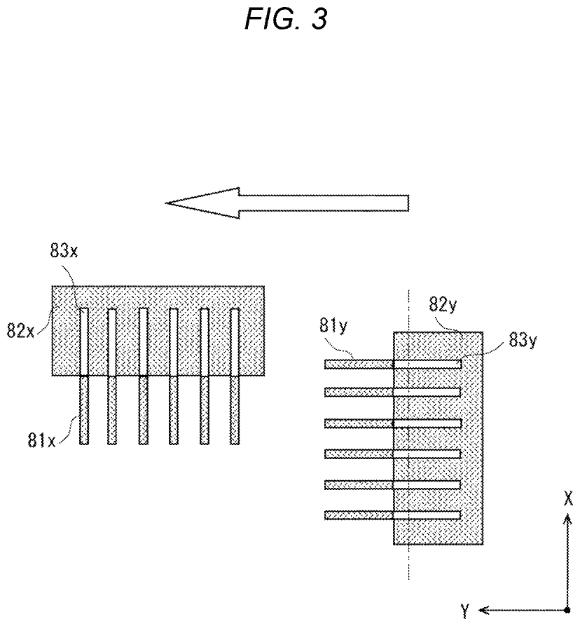

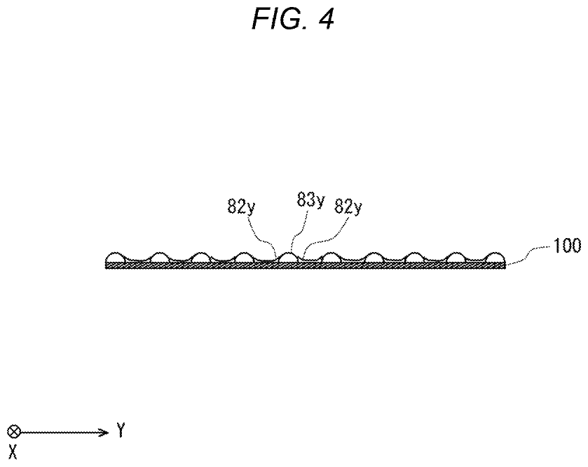

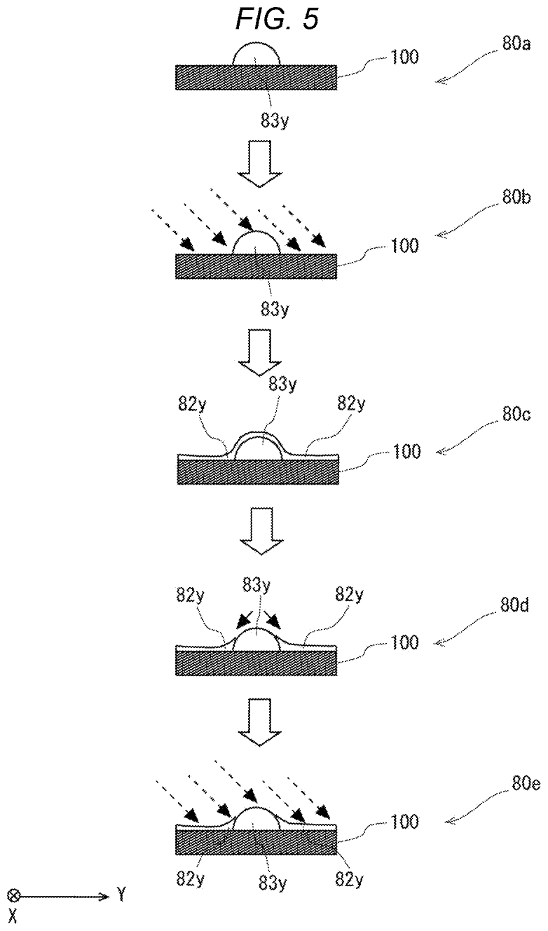

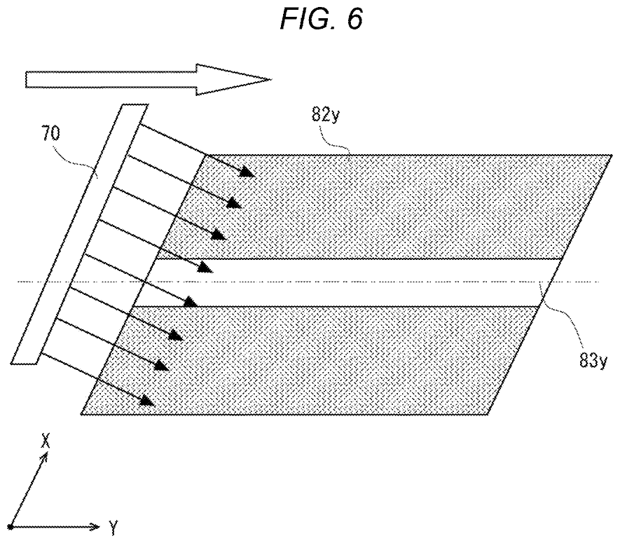

An example of the adjustment pattern to be printed in the printing system 1 and how the sensor 70 senses the adjustment pattern will next be described with reference to FIGS. 3 to 6. FIG. 3 is a diagrammatic view showing an example of the adjustment pattern. FIG. 4 shows an X-direction cross section of a ruled-line-shaped, Y-direction pattern taken along the one-dot chain line, the pattern being a portion of the adjustment pattern shown in FIG. 3 and having a length component in the Y direction. In other words, FIG. 4 is a diagrammatic view showing a cross section of the Y-direction pattern taken along the one-dot chain line with the Y direction being the direction of a normal to the cross section. FIG. 5 is a diagrammatic view showing the process of forming the adjustment pattern shown in FIGS. 3 and 4. FIG. 5 diagrammatically shows, for simplification, only one extracted line of the Y-direction pattern and the process of forming the one line. FIG. 6 is a diagrammatic view showing how the Y-direction pattern shown in FIGS. 3 and 4 is sensed by the sensor 70.

The control unit 10 controls the discharge of the color ink or the discharge of the color ink and the transparent ink performed by the printing unit 50. Note that the control unit 10 also controls the curer and the sensor 70. In particular, to print the adjustment pattern described above at the base material 100, which is a medium, the control unit 10 performs the following control. The following description will be made with reference to a case where the adjustment pattern includes two patterns used to adjust the landing positions in the X and Y directions, but not necessarily, and the adjustment pattern may include only one of the patterns.

The control unit 10 first controls a first ink recording head of the printing unit 50 to form a first pattern with the first ink. The first color, which is the color of the first ink, can, for example, be white or transparent, but is not limited thereto, and is in particular a color that provides a small difference in color from the color of the base material 100 and has poor visibility.

The control unit 10 causes the first ink of the first pattern to cure to form a first product, which is the product produced by the cured first ink, at the base material 100. The product may be referred to as a cured product.

The control unit 10 then controls a second ink recording head of the printing unit 50 to discharge the second ink to the base material 100 on which the first product has been formed in a way that a second region containing a first region, where the first product has been formed, is filled with the second ink. Note that the term “filled” refers to being filled uniformly, but there may be unevenness to some extent.

The curer is configured to cure the first ink and the second ink discharged to the base material 100 at different timings, as described above. The configuration described above can be realized, for example, by arranging UV irradiators at multiple locations as shown in FIG. 2. At the time of printing the adjustment pattern, the control unit 10 causes the second ink in the second region to cure after a predetermined period has elapsed from the discharge of the second ink.

The printing of the adjustment pattern will be described with reference to a case where the color of the base material 100 is white, the first color is white, and the second color is black. The control unit 10 controls the recording head 51w to generate the first pattern with the white ink, and causes the UV irradiator 61w to cure the white ink. The description will be made with reference to a case where the first pattern includes multiple straight ruled lines 83x arranged in parallel and multiple straight ruled lines 83y arranged in parallel, as shown in FIG. 3 by way of example. The ruled lines 83y are each a ruled line having a length component in the reading direction. The ruled lines 83x are each a ruled line having a length component in the direction perpendicular to the reading direction.

Note that the “ruled lines” in the specification of the present application are each intended to be a line segment having a predetermined length or a broken line configured h multiple line segments with a gap therebetween. The multiple line segments and the gap therebetween may be so sized that the combination of the line segments and the gap therebetween can be recognized as a broken line. Furthermore, the sizes of the line segments and the gap therebetween may each not be fixed throughout the broken line, unlike a one-dot chain line.

The “length component” in the specification of the present application is intended to be a component of the length, which corresponds to the long sides of each of the ruled lines described above, out of the width and the length of the ruled line. For example, “having a length component in the reading direction” is intended to mean that the reading direction is substantially parallel to the direction of the long sides of each of the ruled lines. The same applies, of course, to a case where the ruled lines are broken lines, and it is intended that a direction in which the length of the combination of a line segment and a gap that constitute the broken line corresponds to the long sides is substantially parallel to the reading direction.

The first pattern including the multiple ruled lines 83x and 83y shown in FIG. 3 is thus formed as the first product at the base material 100. Note in FIG. 3 that an open arrow indicates the reading direction, in which the sensor 70 performs reading that is performed later, that is, a scan direction, and that the reading direction may be opposite the direction shown in FIG. 3.

The control unit 10 then controls the recording head 51b to discharge the black ink to the base material 100 on which the first product has been formed in a way that the second region containing the first region, where the first product has been formed, with the second regions filled with the black ink. A second region 82x containing the multiple ruled lines 83x and a second region 82y containing the multiple ruled lines 83y are thus formed at the base material 100 filled with the black ink. However, at the time of landing of the black ink, the second regions 82x and 82y cover the ruled lines 83x and 83y, respectively, so that the ruled lines 83x and 83y cannot be visually recognized, unlike the situation shown in FIG. 3.

To perform the filling operation, the control unit 10 may instead control the recording head 51b to simultaneously form straight ruled lines 81x and 81y with the black ink for reference at positions adjacent to or separate from the positions of the ruled lines 83x and 83y. The ruled lines 81x and 81y may be formed in parallel to the straight X-direction ruled lines 83x and Y-direction ruled lines 83y formed with the white ink, respectively. The ruled lines 81x are used, for example, to acquire the landing positions of the X-direction ruled lines 83x based on the relative positional relationship between the ruled lines 81x and 83x extending in the X direction. The ruled lines 81y are used, for example, to acquire the landing positions of the Y-direction ruled lines 83y based on the relative positional relationship between the ruled lines 81y and 83y extending in the Y direction. The intervals at which the ruled lines 81 are arranged are not limited to the equal intervals as shown in FIG. 3. Furthermore, the positions where the ruled lines 81y are disposed in the X direction are not limited to positions between the Y-direction ruled lines 83y. Furthermore, the positions where the ruled lines 81x are disposed in the Y direction are not limited to positions between the X-direction ruled lines 83x.

The control unit 10 then controls the UV irradiator 61b to cure the black ink after a predetermined period elapses from the discharge of the black ink. Note that the target of the curing control in this process may be at least one of the UV irradiator 62 and the UV irradiator 63 in place of the UV irradiator 61b or in addition to the UV irradiator 61b.

As described above, in the curing control described above, the UV irradiation may be performed only by any of the UV irradiators such as the UV irradiator 61b downstream of the recording head 51w and the recording head 51b, as shown in FIG. 2. Still instead, the curing control described above may be only control of any one of the conveyance speed of the base material 100, the timing of UV irradiation, and the amount of irradiation by taking the arrangement described above into consideration.

The predetermined period described above is a period required for the black ink to flow from the ruled lines 83x and 83y to expose the ruled lines 83x and 83y, and only needs to be appropriately set in accordance with the viscosity of the ink, the thickness of the ruled lines 83x and 83y, and other factors. The predetermined period can be stored as a set value in a storage device that is not shown, and can therefore be referred to when the adjustment pattern is printed. The predetermined period can be obtained, for example, by performing test printing in advance with a predetermined type of ink and the ruled lines 83y having a predetermined thickness, and measuring a period spent until the black ink discharged onto the cured ruled lines 83y flows to expose the ruled lines 83y.

In the operation of exposing the ruled lines 83x and 83y, it is not necessary to expose all the ruled lines for a reason described later.

The ruled lines 83y exposed by the flow of the black ink are each a ruled line having an arcuate shape protruding upward in a plane perpendicular to the Y direction, which is the reading direction, as shown in FIG. 4 by way of example. Although not shown, the ruled lines 83x are each a ruled line having an arcuate shape protruding upward in a plane perpendicular to the X direction. When the ruled lines 83x and 83y are exposed and then the black ink is cured, the second region 82y, which is a region filled solid with the black ink, is formed at the base material 100 around the ruled lines 83y, and similarly the second region 82x, which is a region filled solid with the black ink, is formed at the base material 100 around the ruled lines 83x. Note that when the black ink is cured, the ruled lines 81x and 81y are also formed at the base material 100 at the same time. As a result, the printed matter 1000 configured with the base material 100 on which the adjustment pattern shown in FIG. 3 is formed is generated.

The ruled lines 83y formed earlier as described above are exposed on the front surface as the black ink discharged onto the ruled lines flows. Furthermore, since the black ink having flowed functions as an undercoat, a difference in color between the exposed portion and the undercoat is secured, so that the landing position can be accurately sensed.

In a portion adjacent to the exposed portion of the ruled lines 83y exposed and formed as described above, a region having a large amount of black ink is formed as shown in the portion 80d in FIG. 5 by way of example, and therefore shows a black tone different from that of the portion other than the adjacent portion. Specifically, the density of the black ink in the adjacent portion is higher than that in the region filled solid with the black ink other than the adjacent portion. That is, in the second region 82y, the black tone in the portion adjacent to the exposed portion of the ruled lines 83y differs from that in the portion other than the adjacent portion, so that the exposed ruled lines 83y can be distinguished from the second region 82y. Note that the adjacent portion and the non-adjacent portion may be referred to as a boundary portion and a non-boundary portion, respectively.

FIG. 4 is described with reference to a case where the ruled lines 83y each have a semicircular cross-sectional shape, but the shape is not limited thereto, and changes in accordance with the amount of droplet, the viscosity, the control of curing, and other factors of the white ink. For example, the ruled lines 83y may each have a cross-sectional shape of an arc of a circle, or may have a cross-sectional shape of a portion of an arc of a non-circle that approximates an ellipse. In addition, the thickness of each of the ruled lines 83y formed as a sensing target varies in accordance with the degree of the flowing black ink until the black ink is cured. Note that the shape and thickness of the ruled lines 83x are the same as those of the ruled lines 83y.

The process of forming the adjustment pattern shown in FIG. 3, specifically, the Y-direction pattern shown in FIG. 4 will next be described with reference to FIG. 5. The white ink is first discharged to form the ruled lines 83y with the white ink on the base material 100, as shown in the state labeled with 80a. The UV irradiator 61w then performs UV irradiation on the discharged white ink, as shown in the state labeled with 80b, so that the white ink cures. The black ink is then so discharged that the second region 82y containing the region of the cured white ink is filled with the black ink, as shown in the state labeled with 80c.

Thereafter, when the time elapses, the black ink in the second region 82y flows in the direction indicated by the arrows, so that the ruled lines 83y formed by the cured white ink are exposed, as shown in the state labeled with 80d. After the predetermined period has elapsed from the discharge of the black ink, the UV irradiator 61b or the like performs UV irirradiation to cure the black ink. The Y-direction pattern shown in FIG. 4 is thus formed. The X-direction pattern is also formed on the base material 100 simultaneously with the Y-direction pattern, as the Y-direction pattern is.

How the sensor 70 senses the adjustment pattern containing the ruled lines 83y described above will be described. The sensor 70 can include, for example, a irradiator that irradiates light and a light receiver that receives the light reflected off the ruled lines. The irradiator may cause the light to be incident, for example, on the base material 100 on which the ruled lines 83y have been formed at an angle of incidence that is not 0°, as diagrammatically indicated by multiple arrows in FIG. 6. Note also in FIG. 6 that the white arrow refers to the reading direction.

When the light irradiated from the sensor 70 is received as described above, the exposed portion of the ruled lines 83y, an adjacent portion of the second region 82y adjacent to the exposed portion of the ruled lines 83y, and a non-adjacent portion of the second region 82y show a difference in the intensity of the reflected light received by the light receiver, as described above. Specifically, in the present embodiment, the thickness of the second region 82y changes in accordance with the presence or absence of the ruled lines 83y, so that the color of the second region 82y can be changed. For example, when the second region 82y is black, the adjacent portion adjacent to the ruled lines 83y can be visually recognized at any angle as black that is darker than the color of the discharged black ink. The exposed ruled lines 83y can therefore be sensed at any angle as the ruled lines by the sensor 70.

As described above, in the present embodiment, in which the adjustment pattern is formed with the timing at which the white ink is cured and the timing at which the black ink is cured being different from each other, even when the white ruled lines 83y are formed first, the second region that functions as an undercoat can be formed later, so that the landing position of the white ink can be detected. Furthermore, since the ruled lines formed by the method described above show a difference in color tone not only between the exposed portion of the ruled lines 83y and the second region but also between the adjacent portion and the non-adjacent portion, the landing position of the ejected ink can be accurately detected even when the exposed portion has a small area. The ruled lines 83y to be formed by discharged ink or the ruled lines 83y to be eventually exposed do not necessarily have a specific thickness, and may have any thickness as long as the thickness of the exposed ruled lines 83y or the thicknesses of the exposed ruled lines 83y and the adjacent portion function as an adjustment pattern used to adjust the landing position. The same applies to the ruled lines 83x.

As can be seen from the above description, in the present embodiment, the ruled lines 83y are so contained in the adjustment pattern that the landing position can be sensed with high accuracy irrespective of the configuration of the sensor 70 or the angle at which an inspector who checks the landing position views the landing position. The present embodiment therefore allows accurate sensing of the adjustment pattern used to adjust the landing position of the ink having a color that is difficult to visually recognize on the base material 100. Furthermore, in the present embodiment, with respect to curable ink, the accuracy of sensing the landing position of liquid having poor visibility such as white ink can be improved by a simple configuration in which the landing order of the white ink and ink having another color and the curing order of the white ink and the other color ink are skillfully set.

The sensor 70 may be provided as an in-line sensor, that is, in the path along which the base material 100 is conveyed, as shown in FIG. 1 by way of example. In this case, to sense the adjustment pattern, the sensor 70 is, of course, provided at a position where the sensor 70 can detect the printed matter 1000 on which the print head has performed printing. The sensor 70 may, for example, be a line sensor in which a group of sensors are arranged in a direction perpendicular to the conveyance path.

The printing system 1 shown in FIG. 1 by way of example is a system incorporating the print head as a portion of a line-by-line printing apparatus. The print head includes nozzles via which multiple types of color ink are discharged and which are arranged across the width of the print region of the base material 100 in a direction perpendicular to the conveyance direction of the base material 100. As described above, when the printing system 1 includes a line-by-line printing apparatus, the sensor 70 can be disposed in the conveyance path of the base material 100, so that the sensor 70 can perform sensing in a shorter period than in a case where the sensor 70 is otherwise disposed.

The print head may have a configuration in which the nozzles via which the first ink is discharged are located upstream of the nozzles via which the second ink is discharged in the path along which the base material 100 is conveyed, as exemplified by the printing unit 50 in FIG. 2. For example, the recording head 51w, which incorporates nozzles via which the white ink is discharged, may be located most upstream in the conveyance direction, as shown for the white ink in FIG. 2 by way of example. Since white ink is often used as an undercoat when the image layer is formed with color ink, it is desirable to dispose the recording head 51w at an upstream position even in a scene in which an image desired by a user is printed. Disposing a recording head incorporating the nozzles for the white ink, which is an example of the first ink, and the second ink as described above therefore allows the curing to be readily performed in the order shown in the present embodiment without changing the positions of the multiple types of ink only for printing the adjustment pattern or without feeding the base material 100 backward. Note that the recording heads each incorporating nozzles via which color ink other than white ink is discharged may be arranged in any order in the conveyance direction. In addition, since the transparent ink is used in many cases to form the uppermost layer for finishing purposes, for example, for putting gloss on an image, it is desirable to dispose the recording head 52 at a downstream position also in a scene in which an image desired by the user is printed.

Advantages of the present embodiment in which the thus configured print head is employed will be described with reference to Comparative Example. In Comparative Example, a combination of the first color that is white and the second color that is black is employed, and the arrangement of the recording heads shown in the printing unit 50 in FIG. 2 is employed, as in the example described above. White is an example of a color having low visibility, and black is an example of a color having high visibility. In Comparative Example, to print the adjustment pattern shown in FIG. 3, an undercoat layer is formed on the base material 100 with black ink, and then ruled lines are formed at the undercoat layer with white ink.

In Comparative Example, however, the adjustment pattern described above cannot be formed in normal printing steps due to the recording head arrangement in which the recording head 51w incorporating nozzles via which the white ink is discharged is disposed at the most upstream position in the conveyance direction. It is therefore necessary in Comparative Example to swap the position of the recording head 51w for white and the position of the recording head 51b for black, or swap the position of the recording head 51w for white and the position of a recording head for another color disposed downstream of the recording head 51b. Instead, it is necessary in Comparative Example to first form an undercoat layer on the base material 100 with black ink, then perform back feeding of conveying the base material 100 in the direction opposite the conveyance direction, and forming ruled lines with white ink on the undercoat layer. In any of the methods described above, it takes a long time to print the adjustment pattern in Comparative Example. Furthermore, in Comparative Example, when the configuration in which a sensor such as a line scanner is provided downstream of all the recording heads to sense the adjustment pattern is employed, it takes a long time from the start of the formation of the adjustment pattern to the end of the sensing. In contrast, in the present embodiment, the adjustment pattern shown in FIG. 3 can be printed without changing the positions of the multiple types of ink only for printing the adjustment pattern or without feeding the base material 100 backward, as described above.

In the present embodiment, although the second region is formed later, the color liquid corresponding to the undercoat flows along the shape of the ruled lines having cured earlier, so that the ruled lines have a shape raised higher than the second region after the color liquid flows. Therefore, in the present embodiment, the landing position can be so sensed that the color tone at the landing position differs from those at the other positions irrespective of the angle at which the landing position is viewed, and the landing position can be accurately sensed irrespective of the configuration of the sensor 70 or the angle at which an inspector who checks the landing position views the landing position.

The description has been made with reference to the case where the color of the base material 100 is white, the first color is white, and the second color is black, and the combination of the colors is not limited thereto. For example, when the base material 100 is a colored medium and both the first color and the second color are colored, and when the difference in color between the base material 100 and the first color is set smaller than the difference in color between the base material 100 and the second color, the adjustment pattern can be sensed, that is, the first pattern can be sensed with increased accuracy.

One or both of the medium and the first color are colorless and transparent in some cases. In such cases, the second color may be a color that reflects the light irradiated from the sensor 70 at reflectance lower than that of the first color. For example, when the base material 100 is a colored medium, the first color is colorless, and the second color is colored, the reflectance of the second color is set lower than that of the first color. Therefore, the portion where the first color is exposed reflects a large amount of the light irradiated from the sensor 70, and the portion where the second color is exposed absorbs a large amount of the light irradiated from the sensor 70, reflects a small amount of light. As a result, the second region is dark, and the portion where the ruled lines are exposed is bright, so that the sensing can be performed based on the difference in brightness. Therefore, when one or both of the medium and the first color are colorless and transparent, the adjustment pattern can be sensed with increased accuracy by setting the reflectance of the second color lower than that of the first color.

When one or both of the medium and the first color are colorless and transparent, and the incident light passes through the medium, it is difficult to sense the landing position, so that it is desirable that the reflected light can be sensed by causing the incident light to be incident on the adjustment pattern at an angle that is not 0°.

FIGS. 3 to 6 have been described with reference to the case where the adjustment pattern contains not only the ruled lines 83y, which extend in the Y direction, which is the reading direction, and is therefore difficult to sense, but also the ruled lines 83x, and the sensor 70 can still sense the ruled lines even when the adjustment pattern contains any one of the ruled lines 83y and 83x.

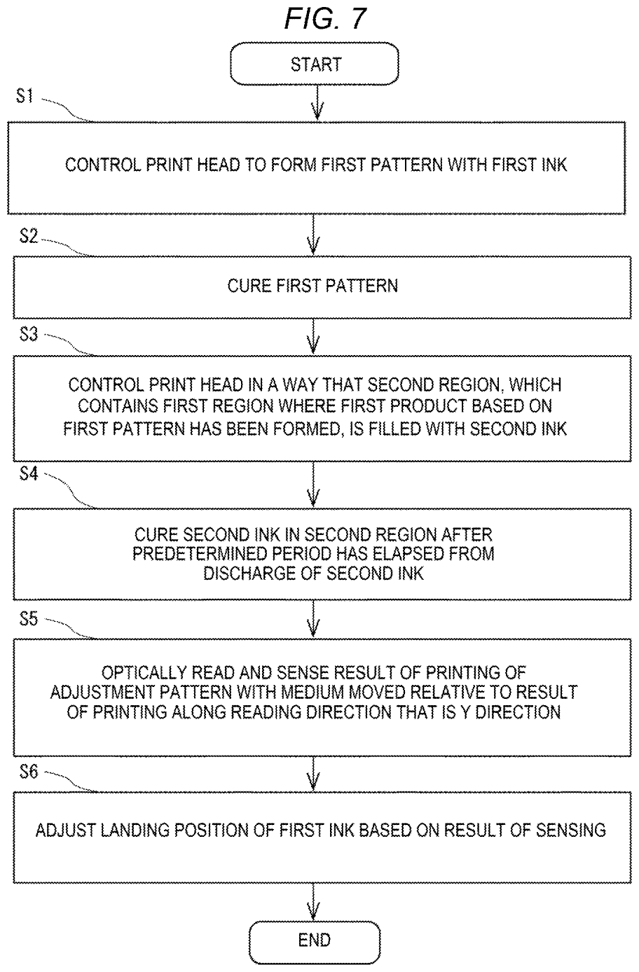

An example of a landing position adjustment method including the printing method used with the printing system 1 will next be briefly described with reference to FIG. 7. FIG. 7 is a flowchart showing an example of the landing position adjustment method including the printing method used with the printing system 1.

In the landing position adjustment method, the printing system 1 carries out a printing process of printing an adjustment pattern used to adjust the landing position of at least the first ink on the base material 100, and an adjustment process of adjusting the landing position based on the printed adjustment pattern.

The control unit 10 of the printing system 1 first controls the print head exemplified by the printing unit 50 to form the first pattern with the first ink (step S1). The control unit 10 then causes the first ink of the formed first pattern to cure (step S2). In the example described above, the control unit 10 causes the recording head 51w to discharge the white ink and causes the UV irradiator 61w to cure the white ink.

The control unit 10 then controls the print head to discharge the second ink to the base material 100 on which the first product based on the first pattern has been formed in a way that the second region containing the first region, where the first product has been formed, is filled with the second ink (step S3). The control unit 10 causes the second ink in the second region to cure after a predetermined period has elapsed from the discharge of the second ink (step S4). In the example described above, the control unit 10 causes the recording head 51b to discharge the black ink, and causes the UV irradiator 61b or the like to cure the black ink after a predetermined period has elapsed from the discharge of the black ink.

The control unit 10 then controls the sensor 70 to sense the printed result. The sensor 70 optically reads and senses the printed result of the adjustment pattern at the medium printed with the cured first ink and second ink while the medium is moved relative to the sensor along a reading direction that is the Y direction (step S5).

The control unit 10 finally adjusts the landing position of the first ink based on the result of the sensing of the adjustment pattern containing the first pattern printed with the first ink and sensed by the sensor 70 (step S6), and terminates the process.

The adjustment of the landing position in step S6 can be performed by using an existing technology. The adjustment will be briefly described. For example, when the detected white ruled lines deviate in the X direction, the control unit 10 changes the combination of nozzles via which the ink has been discharged at the corresponding landing position to a combination of adjacent nozzles in accordance with the position where the ink has landed on the ruled lines. For example, when the detected white ruled lines deviate in the Y direction, the control unit 10 changes the timing at which the ink landed at the corresponding landing position has been discharged via the nozzles in accordance with the position where the ink has landed on the ruled lines to perform adjustment to eliminate the deviation.

The adjustment described above may be so performed that color reference lines as exemplified by the ruled lines 81x and 81y are contained in the adjustment pattern, and the deviation is eliminated based on the deviation of the white ruled lines from the reference lines. Other application examples

Note that the present disclosure is not limited to the embodiment described above and can be changed as appropriate to the extent that the change does not depart from the intent of the present disclosure. For example, in the present embodiment, to improve the accuracy of sensing ink having poor visibility, the adjustment pattern is formed with the ink having poor visibility, and the adjustment pattern can also be formed with ink having good visibility. The transparent ink has been described as ink containing no coloring material, and the transparent ink may contain a tiny amount of coloring material as long as the ink transmits and reflects light to some extent so as to provide the advantages of the disclosure of the present application. The UV irradiator for the final curing only needs to be capable of performing UV irradiation having intensity higher than the intensity of the UV irradiation from the UV irradiator for temporary curing. The curing of the ink is not limited to curing UV ink by irradiating the UV ink with UV light, and thermosetting ink may be heated to cure.

The printing system including the line-by-line printing apparatus has been described as the present embodiment, and the present disclosure is also applicable to a printing system including a serial printing apparatus. In the case of the serial printing apparatus, the reading direction is perpendicular to the conveyance direction. The present embodiment is widely applicable to apparatuses using the inkjet technology, such as a copier, a facsimile, and a multifunction machine having the functions of a copier and a facsimile. The sensor exemplified by the sensor 70 is not necessarily provided in the path along which the medium is conveyed, and may be provided in another apparatus. That is, in the printing system 1, the printing apparatus and the sensor 70 may be constructed as separate apparatuses. The printing system 1 may be a printing apparatus having one scanning function, and in this case, after the adjustment pattern is printed, the adjustment pattern may be sensed by the user placing the printed matter on a document platen or an automatic document feeder and causing the printing apparatus to scan the printed matter.

The program described above contains a group of commands (or software codes) that cause a computer to perform one or more functions described in the embodiment when the program is read into the computer. The program may be stored on a non-transitory computer-readable medium or a tangible storage medium. The computer-readable medium or the tangible storage medium may include, as an example, but not limited to, a random-access memory (RAM), a read-only memory (ROM), a flash memory, a solid-state drive (SSD), or another memory technology. The computer-readable medium or the tangible storage medium may further include, as an example, but not limited to, a CD-ROM, a digital versatile disc (DVD), a Blu-ray (registered trademark) disk, or another optical disc storage, a magnetic cassette, a magnetic tape, a magnetic disk storage, or another magnetic storage device. The program may be transmitted on a transitory computer-readable medium or a communication medium. The transitory computer-readable medium or the communication medium may include, as an example, but not limited to, a signal that propagates electrically, optically, acoustically, or in other forms.

The present disclosure has been described with reference to the embodiment described above. The present disclosure is not limited only to the configuration in the embodiment described above, and it goes without saying that the present disclosure includes various variations, modifications, and combinations that can be achieved by those skilled in the art within the scope of the disclosure in the claims of the present application.

What is claimed is:

1. A printing system comprising:
a print head configured to discharge first ink and second ink to a medium, the first ink being liquid having a first color and being curable, and the second ink being liquid having a second color and being curable;
a control unit configured to control the print head to discharge the first ink and the second ink;
a curer configured to cure the first ink and the second ink discharged to the medium at different timings; and
a sensor configured to sense a printed result using the first ink and the second ink after curing by the curer,
wherein the control unit is configured to
control the print head to form a first pattern with the first ink, and
control the print head to discharge the second ink to the medium on which a first product is formed, the first product being a product after the first ink of the first pattern is cured, in a way that the second ink is discharged to a second region containing a first region where the first product is formed, and
the curer is configured to cure the second ink in the second region after a predetermined period elapses from the discharge of the second ink.

2. The printing system according to claim 1, wherein
the medium is a colored medium,
the first color and the second color are both colored, and
a difference in color between the medium and the first color is smaller than a difference in color between the medium and the second color.

3. The printing system according to claim 1, wherein
when at least one of the medium and the first color is colorless, reflectance of the second color is lower than reflectance of the first color.

4. The printing system according to claim 1, wherein
the printing system is a system incorporating the print head as a portion of a line-by-line printing apparatus, and
the print head has a configuration in which a nozzle configured to discharge the first ink is located upstream of a nozzle configured to discharge the second ink in a path along which the medium is conveyed.

5. The printing system according to claim 1, wherein
the sensor is provided in a path along which the medium is conveyed, and
the sensor is configured to optically read and sense the printed result on the medium while the medium is moved relative to the sensor along a reading direction.

6. The printing system according to claim 1, wherein
the printed result is a printed result at least an adjustment pattern used to adjust at least a landing position of the first ink on the medium.

7. A printing method performed by a printing system including a print head configured to discharge first ink and second ink to a medium to print a first pattern, the first ink being liquid having a first color and being curable, and the second ink being liquid having a second color and being curable, the printing method comprising:
controlling the print head to form the first pattern with the first ink;
curing the first ink of the formed first pattern;
controlling the print head to discharge the second ink to the medium on which a first product is formed, the first product being a product after the first ink of the first pattern is cured, in a way that the second ink is discharged to a second region containing a first region where the first product is formed;
curing the second ink in the second region after a predetermined period elapses from the discharge of the second ink; and
sensing a printed result using the first ink and second ink after curing.
